(19) United States
(12) Patent Application Publication
(10) Pub. No.: US 2004/0045465 A1
(43) Pub. Date: Mar. 11, 2004

(54) Four color digital printing process and color image element using color-sensitive photopolymers

(76) Inventors: Michael E. McLean, Etowah, NC (US); Douglas C. Neckers, Perrysburg, OH (US); Petr Serguievski, Salt Lake City, UT (US); Alexander Mejiritski, Bowling Green, OH (US); Oleg Grinevich, Bowling Green, OH (US)

Correspondence Address: Killworth, Gottman, Hagan & Schaeff, L.L.P, Suite 500, One Dayton Centre, Dayton, OH, 45402-2023, US

(21) Appl. No.: 10/241,066

(22) Filed: Sep. 11, 2002

(51) Int. Cl. B41C 1/00; B41N 6/00

(52) U.S. Cl. 101/401.1

(57) ABSTRACT

A process of forming a color image element with color-forming photopolymer layer(s), the color image element so formed, and a digital imaging system is provided. A single subtractive working color-sensitive, photopolymerizable layer on a substrate which, upon exposure to an actinic radiation source reflected from a digital light processor accurately reproduces a desired digital color image in the photopolymerizable layer. The use of multiple layers of color specific photopolymers enable a full color image to be formed upon the substrate by this process.

### BACKGROUND OF THE INVENTION

The present invention is directed to color printing, and more particularly to a method of forming a color image using color-sensitive photopolymers and a digital imaging process and system.

Imaging devices for use in graphic arts reproduction such as, for example, offset printing presses, flexographic printing presses, gravure printing presses, inkjet printers, electrophotographic printers, and related printing processes all create a desired colored image by depositing on a substrate, microscopic dots consisting of the individual colorant materials. The term “graphic arts” as used herein refers to the formation of visible images made of microscopic dots for reproduction, but the term does not refer to the formation of topographical elements or three dimensional models. In order to produce the desired color image on a substrate, the displayed picture elements (pixels) on the monitor must be converted to these microscopic dots. This conversion process is carried out by a raster image processor (RIP) which interprets the RGB pixels generated by the application program and translates them into data needed by the imaging device's printing engine to produce the dots on the substrate. With such RIP data, such print engines reproduce the colors created by the application program by depositing on the substrate dots of each colorant in exact quantities and in exact relative positions each other.

Problems associated with such a process include for example, colorant spreading, color calibration, and dot misregistration. Some colorant materials, such as ink, have a tendency to flow outwards as it is absorbed by a substrate, wherein too much spreading can create a cloudy or dark image of low quality. This spreading is called dot gain, and a dot size correction (a percentage less than the desired dot size) is typically provided from lookup tables that account for types of substrates and inks used for a print job. If that setting is inappropriate, the color produced will be wrong.

When using the four process colors of cyan, magenta, yellow, and black (CMYK), the quantity of ink deposited by the imaging device is determined by the percentage of the dot that represents each of the four colors. If the imaging device creates a dot different from that indicated by the application program, the final color will not be that of the application program. Accordingly, it is often necessary to measure the resulting color percentages in order to calibrate the RIP. This can be a long and difficult process, because typically after entering the calibration corrections into the application program, another output must then be created and the procedure repeated until the dot percentage created by the imaging device is reasonably close to what it should be for a desire color image.

In addition, it is necessary for such imaging devices to register or line up dot-for-dot each of the deposited process colors in their proper relative positions on the substrate. This process of registering or superimposing the layers of dots in their correct relative positions must be within a tolerance of 1 mil (1000th of an inch) or 25 microns for a quality color output. Improperly registered images give rise to a condition appropriately referred to as misregistration. As such, printer must take care that the printing elements and the substrate are always in proper registration. Often this difficult process is subject to varying degrees of software and mechanic problems.

Accordingly, there is a desire for a color printing method that reproduces the expected color quality of a desire digital image produced by an application program during the printing process, and which eliminates the need for dot calibration and registration.

### SUMMARY OF THE INVENTION

The above-mentioned needs are met by the present invention by providing a process of forming a full-color image using color-sensitive photopolymers and digital imaging, which eliminates the need for dot calibration and registration. The color image is created by exposing one or more photopolymer layers of a photopolymerizable composition with filtered wavelengths of actinic radiation of varying intensities from a digital light processor which forms image spots or pixels in the photopolymer layer(s) of a desired color and density.

In a first embodiment of the invention, the process beings with a substrate that is thinly coated with a first colorless photopolymer layer of a photopolymerizable composition which selectively creates a first color of one of the process colors (CMYK). The photopolymer layer is then photoimaged using a digital light processor which projects actinic radiation in filtered wavelengths of varying intensities to form a first color rasterized image pattern. Next, the substrate is thinly coated with a second photopolymer layer that selectively forms a second color of the remaining process colors, and then photoimaged by the digital light processor to form a second color rasterized image pattern. The process is then repeated with two more photopolymer coatings that selectively form the remaining color rasterized image patterns when photoimaged by the digital light processor.

It is to be appreciated that since the digital light processor provides for controlling both the positioning and the density of the color image patterns formed in the photopolymer layers by a photochemical process, a four-color image in complete registration is produced. Additionally, if desire, four individual color image patterns, as in the case of a set of color separation proofs, may also be produced by the method of the present invention by coating and photoimaging separate substrates each with one of the photopolymer layers.

In another embodiment, the photopolymerizable composition is provided to the substrate as a semi-solid or solid in which the photopolymer and substrate is provided as a stock material to be used in the photoimaging process. Additionally, in still other embodiments multiple layers of varying photopolymerizable compositions and/or thickness may be provided to the substrate in order to form brilliantly colored and/or three-dimensional images. It is to be appreciated that a three-dimensional image may be formed by controlling and varying film thickness of the photopolymer layers as each layer is applied and photoimaged on the substrate.

The present system possesses two qualities that enable it produce very high quality images: a spot or pixel size of approximately 16 microns, and the ability to accurately expose the raster image patterns in perfect registration because the substrate is stationary during the irradiation procedure. In using a photopolymerizable composition provided to a substrate, it is unnecessary to place colorant materials in registration by a transfer device. Since only the process steps of providing a substrate with a photopolymerizable composition and photoimaging the substrate are required to form the color image, a much simpler process is provided.

The above process can be performed in a color copier, a color printer, or for color proofing. Additionally, the process may be implemented by having both the substrate and digital light processor fixed while a moving applicator is used to apply the photopolymer layers. Alternatively, a rotating belt/drum or moving web may pass coating and exposure stations, or all the photopolymer layers necessary for the current application may be applied to the substrate wherein the digital light processor exposes all layers at once to form the color image.

These, and other features and advantages of the present invention, will become apparent from the following detailed description, the accompanying drawings, and the appended claims.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic diagram of an image-processing device used according to the method of the present invention to produce a color image;

FIG. 2 is a flowchart of the process of forming a color image on a substrate provided with a liquid photopolymer layer according to the present invention;

FIG. 3 is a front view of an image formed according to the process of the present invention;

FIG. 4 is a sectional side view of the image of FIG. 3, taken along section line 4-4; and

FIG. 5 is a side view of another image formed according to the process of the present invention.

### DETAILED DESCRIPTION OF THE PREFERRED EMBODIMENT

In accordance with the present invention, a method of forming a color image using color-sensitive photopolymerizable composition(s) and a digital imaging process is provided. This process is particularly suitable for producing color proofs, color separations, and color images on various types of substrates such as, for example, metals, wood, ceramics, paper, film, glass, and plastics. The substrate may be in the form of a sheet, cylinder, or almost any other configuration.

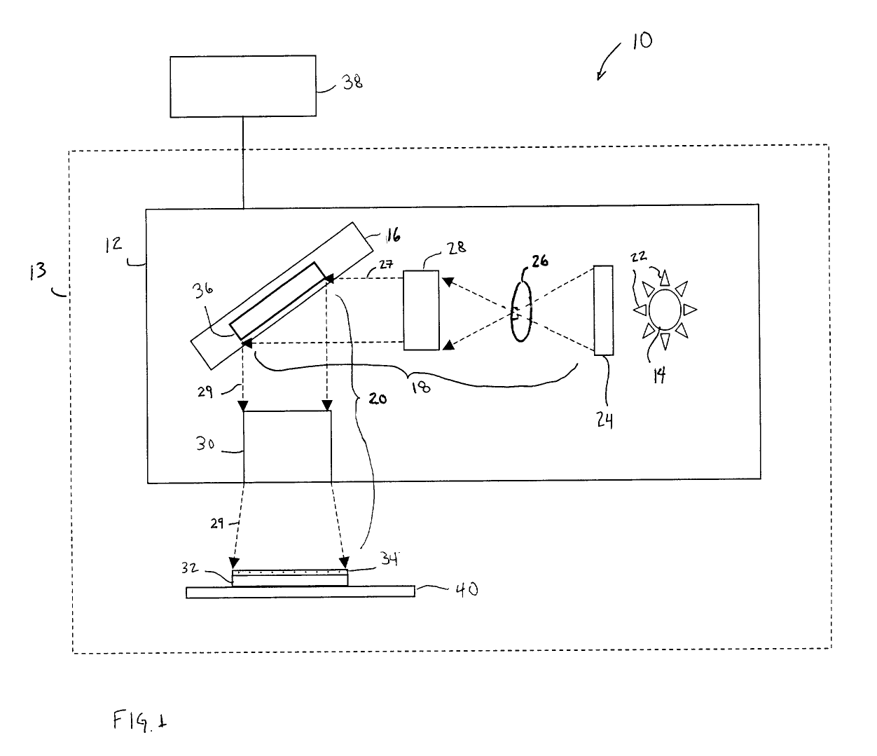

As illustrated in FIG. 1, an apparatus or digital light imaging system 10 for forming a color image element according to the present invention is shown. The digit light imaging system 10 is conceptually an f/4 projection system with various electro-mechanical and optical elements to project filter wavelengths of actinic radiation in precise image patterns. A main housing 12 is the primary structural member as well as a light baffle. An additional housing or light-free room 13 may also be employed to eliminate exposure to extraneous light sources.

Interior to the main housing 12, the imaging system preferably includes at least one light source 14, an optical path, and at least one digital light processor 16. The light source 14 is a visible light that provides actinic radiation to cure or polymerize the photopolymerizable composition. Preferably, the light source 14 is a metal halide lamp, however, other light sources may be used such as for example, tungsten halogen and xenon lamps. In particular, the metal halide lamp should be unfiltered and have enough wattage, such as 270W, to suitably cross-link the photopolymerizable composition. Lamps of higher light intensity may also be used to increase the rate of polymerization.

The optical path of the imaging system comprises an illumination path 18 and a projection path 20. The illumination path 18 starts with light rays 22 from the light source 14 passing into a condenser lens 24. The diverging light rays then are directed at an integrator lens 28, which redistributes the rays into a uniform parallel light input to the digital light processor 16. Depending on the state of modulating elements of the digital light processor 16 certain light rays 27 from the illumination path 18 are then reflected by the digital light processor 16 as an image pattern 29 down the projection path 20. The digital light processor 16, when combined with the light source and the projection optics, can be utilized to precisely control the effective intensity of wavelengths of actinic radiation from the light source using a binary pulse width modulation technique as is explained in greater detail in a later section. For additional wavelength modulation, an optional rotating color wheel 26 may be employed to vary the wavelength range of the actinic radiation. Preferably, the actinic radiation is in the visible regions of the electromagnetic spectrum. However, it is to be appreciated that actinic radiation such as ultraviolet or infrared irradiation may also be used.

The image pattern 29 that is reflected from the digital light processor 16 is directed down the projection path 20 into the pupil of a projection lens 30. The projection lens magnifies the image pattern 29, and projects it onto a substrate 32 having a colorless photopolymer layer 34 of a liquid, semi-solid or solid photopolymerizable composition(s).

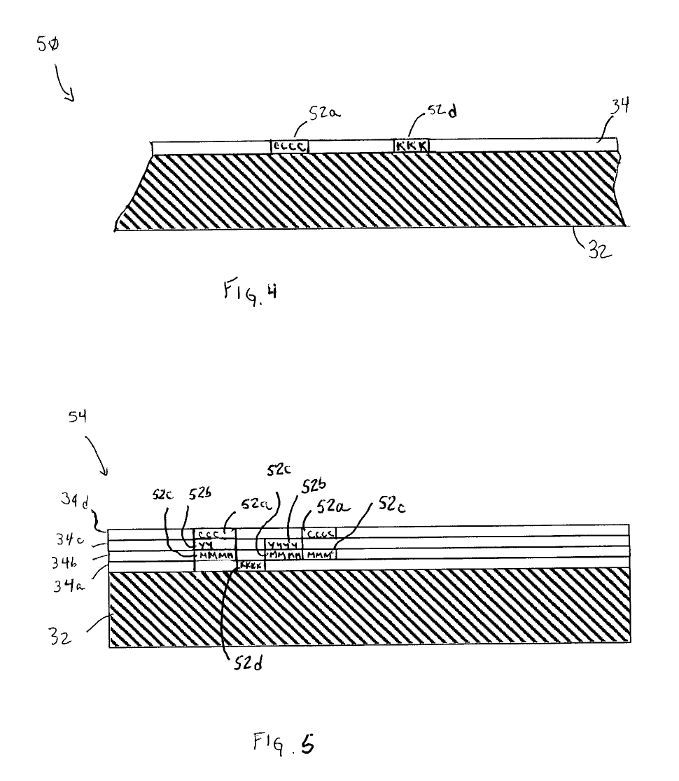

When using a single layer, the photopolymer layer 34 is formed of various photopolymerizable compositions that are photocurable by the wavelength range and intensity of actinic radiation of the received image pattern 29 into the various colored spots 52a and 52d of varied densities, as is illustrated by FIG. 4. Alternatively, multiple layers may be used wherein each of the photopolymer layers 34a, 34b, 34c, and 34d is provided one over each other in order to form a full color image, as is illustrated by FIG. 5. In particular, each of the photopolymer layers 34a, 34b, 34c, and 34d is sensitive to a specific wavelength of actinic radiation and photocurable to form colored spots 52a, 52b, 52c, and 52d of varying densities of one of the desired process colors (e.g., CMYK), as with be explained below. Useful color-sensitive photopolymerizable compositions for the photopolymer layer(s) 34 are described in U.S. Pat. No. 6,200,646, which is herein incorporated in its entirety, and are commercially available from Spectra Group Limited, Inc, as part of its Color-On-Demand technology.

The optical path may also comprise a plurality of lenses or a plurality of lenses in combination with at least one mirror or a plurality of mirrors or in combination with at least one lens. Additionally, it is to be appreciated that instead of the single light source 14 and the color wheel 26, three individual light sources (not shown) each providing one of the RGB colors may also be used. In this alternative embodiment, three separate illumination paths converge at the projection lens 30 to form the image patterns of actinic radiation. A color prism or color filters may also be used to split the white light from the single light source 14 into specific wavelength of actinic radiation components. Each radiation component is then directed to a separate digital light processor, in which the reflected radiation from three digital light processors (not shown) is recombined optically and projected onto the substrate through the projector lens 30.

Also, if desired, a first digital light processor 16 may be used in concert with the color wheel 26 to reflect actinic radiation in the wavelength range that produces blue and green images in the photopolymer layer. A full color image can be completed by using a second digital light processor (not shown) that reflects actinic radiation in the wavelength range that produces red images in the photopolymer layer. However, the use of the single digital light processor 16 is preferred as registration is stable and accurate as all three-component images originate from the same device. Furthermore, it is to be appreciated that using the single projection lens 30 yields the benefits of mechanically pre-aligned convergence and the capability for interchangeable lenses.

The digital light processor 16 selectively modulates the actinic radiation received from the illumination path 18 into a desired image pattern and directs the desired image pattern to the projection lens 30. Specifically, the term digital light processor, as used herein, refers to a light processor that performs this function by converting digital content representing the color image to be formed into a digital bit stream that can be read by an included mirror-type spatial light modulator 36. Preferably, the digital content is composed on a microprocessor 38 that is in communication with the digital light processor 16 for image generation by the imaging system 10. However, other sources of the digital content, such as memory chips, analog-to-digital decoders, video processors, digital signal processors, online databases, web sites, may also communicate with and be processed by the digital light processor 16.

Generally, the mirror-type spatial light modulator 36 is an individually addressable matrix of modulating micromirrors that build digital images based on the provided digital bit stream. Mirror-type spatial light modulators include devices which tilt each micromirror by electrostatic force, devices which tilt each micromirror by mechanical deformation of a fine piezoelectric element, and the like.

One suitable spatial light modulator is the Digital Micromirror Device (DMD) developed by Texas Instruments, which permits imaging resolutions up to 1280 pixels×1024 pixels. However, it is to be appreciated that the present invention can also easily be applied to any projection device that may result in higher resolutions and improved print quality.

The DMD is an optical switch or a reflective spatial light modulator that consists of a matrix of about one million digitally-controlled microscopic mirrors. Each digitally-controlled microscopic mirror is mounted on a hinge structure to allow each mirror to tilt at an angle from a horizontal plane between two states, +theta degrees for “on” or −theta degrees for “off.” For the DMD, the mirror tilt angle is +10 degrees from the plane of the silicon substrate. Included electronics convert incoming data signals into spatial representations on the DMD and control the color wheel 16 that provides a sequential input of actinic radiation of various wavelengths to the digital light processor.

Accordingly, as data “1” of the bit stream is written to a memory cell of the light modulator, the associated micromirror tilts by +theta degrees which directs a pixel of actinic radiation from the light source 14 onto the photopolymer layer(s), via the projection lens 30. As data “0” of the bit stream is written to a memory cell of the light modulator, the associated micromirror tilts by −theta degrees, which directs the light away from the projection lens 30.

It is to be appreciated that each microscopic mirror can be electrically switched “on” and “off” up to approximately 50,000 times per second. Accordingly, with this process of directing actinic radiation to and from the illumination path 20, the effective intensity (and wavelengths if the rotating color wheel is used) experienced by the photopolymer layer(s) 34 can be precisely controlled based on the amount of time each micromirror of the spatial light modulator 36 is in the on position. Accordingly, the cross-linked density of each color-forming photopolymer can also be controlled by varying the exposure time of the photopolymer layers to the various wavelengths of actinic radiation required for the application (e.g. RGB or RGBK).

Additionally, because the light modulator 36 has a plurality of micromirrors arranged in a matrix, a full frame color image is photocurable on the photopolymer layer 34 at one time. Furthermore, because each micromirror has a size of about 16 μm by 16 μm, and the micromirrors are spaced less than 17 microns from each other, this close spacing of the micromirrors results in higher resolution images that are projected as seamless, and with little apparent pixellation. Moreover, with each micromirror being substantially rectangular in shape, each reflected incident of actinic radiation in the image pattern 29 creates a substantially rectangular pixel with extremely sharp edges.

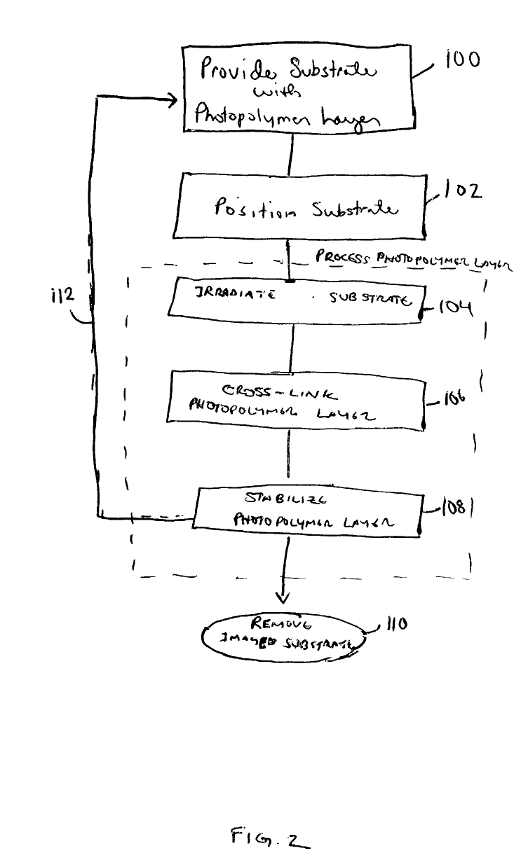

In order that the invention may be more readily understood, reference is also made to FIG. 2, illustrating the method steps of forming a color image according to the present invention, which are intended to be illustrative of a preferred use of the imaging system of the invention, but are not intended to be limiting in scope.

In using the imaging system 10 to produce a color image element, the substrate 32, both shaped and sized appropriately for the intended print job, is provided with the liquid photopolymer layer 34. It is it to be appreciated that the layer 34 may be provided to the substrate 32 by a coating station (not shown) having a liquid reserve of the photopolymerizable composition. In another embodiment, the substrate 32 may be provided as a stock material with a semi-solid or solid photopolymer layer of the photopolymerizable composition.

Next, in step 102 a support assembly 40 (FIG.1) carrying the substrate 32 with the photopolymer layer 34 is positioned relative to the projection lens 30 of the imaging system 10. The support assembly 40 may be movable, such as a rotatable belt/drum or movable web, to automate the positioning of the substrate 32 under the imaging system 10. However, the support assembly 40 is preferably stationary at least during the exposure of the photopolymer layer 34 with actinic radiation. Additionally, while both the photopolymer layer 34 and imaging system 10 may remain stationary during the irradiation procedure, one or the other may also be moving throughout the irradiation.

With the support assembly 40 in proper alignment with the imaging system 10, actinic radiation 22 is then directed down the illumination path 18 through the rotating color wheel 26 in sequentially filter wavelength ranges towards the elements of the light modulator 36 of the light processor 16. The actinic radiation 22 is then processed into the sequential image patterns 29 of filtered wavelength ranges required for the application (e.g., RGB or RGBK) based on an inputted digital bit stream received from the microprocessor 38. Each sequential image pattern 29 is then reflected by the elements of the light modulator 36 through the projection lens 30 to irradiate selected portions of the photopolymerizable layer for cross-linking, as indicated by steps 104 and 106.

It is to be appreciated that the image pattern 29 is formed from each micromirror of the digital light processor 16 sequentially illuminating the photopolymer layer 34 with varying durations of actinic radiation in the filtered wavelength range. As such, the photopolymers in the photopolymer layer 34 which are sensitive to the received wavelength range of the actinic radiation are cross-linked to varying densities with respect to each other based on the intensity and duration of the received actinic radiation, thereby forming particular colors (e.g., RGB or RGBK). Because the chemical process of color formation using photopolymerizable compositions is described in greater detail in U.S. Pat. No. 6,200,646, which is herein incorporated by reference, no further discussion is provide for the sake of brevity.

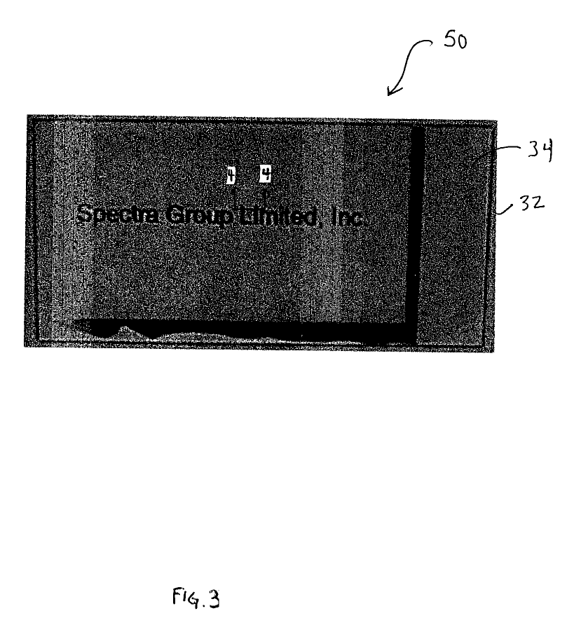

As illustrated in FIG. 3, a color image 50 may be formed according to the above-described process upon the substrate 32 in the photopolymer layer 34. Viewing a sectional side view taken along section line 4-4 of FIG. 3, the color image 50 comprises a plurality of substantially rectangular, colored-photopolymer spots or pixels 52a and 52d, which are illustrated in FIG. 4. Although the image 50 in FIG. 3 is shown as forming letter, it is to be appreciated that the spots 52 may used to form of any indicia including numbers, letters, graphics, and the like. Additionally, since each micromirror is substantially dimensioned 16 μm by 16 μm, each of the formed spots 52 also have such precise dimensioning, thereby resulting an image 50 with very sharp edges as is illustrated.

Turning back to FIG. 2, the discussion of the color-imaging forming process of the present invention is continued. Once the photopolymer layer 34 has been properly crossed-linked to form the desired color image 50 in step 106, any excess, undeveloped photoresin may be stabilized by exposing layer 34 to a specific wavelength range of actinic radiation in step 108 such that the undeveloped portions of the photopolymer layer 34 remain translucent, hard, inactive, and non-tacky. In step 110, the formed color image 50 is then removed from the system 10.

It is to be appreciated the above-described process may be repeated before removal from the system 10, as indicated by step 112. In this manner, by varying the thickness of the photopolymer layers 34 applied to the substrate 32, a color image 54 having a three-dimensional effect may be formed. Alternatively, multiple layers of a photopolymerizable composition which cure to a specific process color may be provided one over the other for the purpose discussed hereafter.

As illustrated by FIG. 5, by repeating the above process, additional photopolymer layers 34a, 34b, 34c, 34d may be applied, wherein the first coating 34a of the photopolymerizable composition is sensitive to a specific wavelength range of actinic radiation which forms into only one color, such as a process color, depending on the desired color range of the image. After developing and stabilizing the desired color image pattern in the first coating 34a in accordance with steps 100-108, the process is repeated in step 112, by applying a second coating 34b over the first coating 34a. In this embodiment, the second coating is sensitive to a different wavelength range of actinic radiation and forms a different color, such as one remaining process color. Accordingly, by repeating the coating and irradiation steps, a full-color image based on the CMYK color system, or any other color system with additional coatings, such as six or eight colors, may be formed.

Because the process of the present invention forms the color image directly onto the surface of the photopolymer layer 34 with projected wavelengths of actinic radiation there is no distortion of the image, which remains sharp and well defined. Additionally, because this process involving the placement of minuscule mirror-shaped spots of each process color of various densities rather than the repeating pattern of uniform dots, this process eliminates color shifts caused by slight misregistration.

Furthermore, this process eliminates the need for trapping or creating an overlap between abutting colors to compensate for imprecision in the printing process. Because this process does not require the laying down of inks or toners, the need for correcting abutting colors to slightly overlap in order to minimize the effects of misregistration is not required. Moreover, this process eliminates the need for converting the inputted RGB pixel data to CMYK halftone dots. In a sense, this process implements a true WYSIWYG (“What You See Is What You Get”) printing, in that what is displayed on a computer monitor will appear on the color image element.

While certain representative embodiments and details have been shown for purposes of illustrating the invention, it will be apparent to those persons skilled in the art that various changes in the methods and apparatus disclosed herein may be made without departing from the scope of the invention.

What is claimed is:

1. A color image element suitable for use in graphic arts reproduction comprising a substrate and an imaged color photopolymer surface of a plurality of rectangular pixels crossed-linked on said substrate and suitable for use in graphic arts reproduction, wherein said surface has been formed imagewise directly onto said substrate by digital imaging photopolymerization.

2. An color image element as claimed in claim 1 in which said substrate is selected from the group consisting of metals, wood, ceramics, paper, film, glass, and plastics.

3. A method of making a color image suitable for use in graphic arts reproduction comprising the steps of: providing a substrate having a surface; providing a layer of a photopolymerizable composition on at least a portion of said surface of said substrate; and irradiating said layer with actinic radiation reflected by a spatial light modulator in a desired image pattern for a time sufficient to photopolymerize said layer into said color image suitable for use in graphic arts reproduction directly on said substrate.

4. A method as claimed in claim 3 in which said photopolymerizable composition layer is sensitive to visible light.

5. A method as claimed in claim 3 in which said substrate is selected from the group consisting of metals, wood, ceramics, paper, film, glass, and plastics.

6. A method as claimed in claim 3 in which said actinic radiation is generated from a visible light source.

7. A method as claimed in claim 3 in which said desired image pattern is formed of a plurality of substantially rectangular spots of reflected actinic radiation which photopolymerizes selected portions of said photopolymerizable composition layer into said color image having sharp, well-defined substantially rectangular edges.

8. A method as claimed in claim 6 in which said visible light source comprises a metal halide lamp.

9. A method as claimed in claim 3 further including the step of directing said desired image pattern into a projection lens to project said desired image pattern onto said photopolymerizable composition layer.

10. A digital imaging photopolymerization system for providing a color image element suitable for use in graphic arts reproduction, said system comprising: a support assembly adapted to receive a substrate having a layer of a photopolymerizable composition; a light source for irradiating said layer to form a color image suitable for use in grahic arts reproduction on said substrate; a digital light processor for modulating and directing said light source onto said layer in an image pattern that forms said color image; and a microprocessor for controlling the operation of said system.

11. The digital imaging photopolymerization system of claim 10 in which said light source comprises a visible light source.

12. The digital imaging photopolymerization system of claim 10 wherein said digital light processor includes an array of individually addressable micromirror devices for projecting said image pattern onto said photopolymerizable composition layer.

13. The digital imaging photopolymerization system of claim 10 further including a color wheel providing sequential filter wavelength ranges of actinic radiation to said digital light processor.

14. The digital imaging photopolymerization system of claim 13 further including projection optics for projecting said image pattern onto the photopolymerizable composition layer for polymerization into the image.
